(19) United States
(12) Patent Application Publication
(10) Pub. No.: US 2014/0295387 A1
(43) Pub. Date: Oct. 2, 2014

(54) Automated Scoring Using an Item-Specific Grammar

(71) Applicant: Educational Testing Service, Princeton, NJ (US)

(72) Inventors: Michael Heilman, Princeton, NJ (US); Daniel Blanchard, Lawrenceville, NJ (US)

(73) Assignee: Educational Testing Service, Princeton, NJ (US)

(21) Appl. No.: 14/227,181

(22) Filed: Mar. 27, 2014

Related U.S. Application Data
(60) Provisional application No. 61/805,613, filed on Mar. 27, 2013.

(51) Int. Cl. G09B 7/02

(52) U.S. Cl. CPC G09B 7/02
USPC 434/169

(57) ABSTRACT

Systems and methods are provided for scoring a constructed response. The constructed response is processed according to a set of grammar rules to generate a data structure. The grammar rules specify a set of preferred responses for the item. The grammar rules utilize a plurality of variables that specify legitimate word patterns for the constructed response. It is determined whether the data structure indicates that the constructed response is included in the set of preferred responses, and if so, a maximum score is assigned to the constructed response. If the data structure indicates that the constructed response is not included in the set of preferred responses, a partial credit score for the constructed response is determined by assessing from the data structure which ones of the concepts represented by the variables are present in the constructed response. The partial credit score is assigned based on the presence of the concepts.

### CROSS-REFERENCE TO RELATED APPLICATIONS

This application claims priority to U.S. Provisional Patent Application No. 61/805,613, filed Mar. 27, 2013, entitled “Item-specific Grammars for Automated Short Response Scoring,” which is incorporated herein by reference in its entirety.

### FIELD

The technology described in this patent document relates generally to automated scoring of a constructed response and more particularly to the use of a set of grammar rules for automatically scoring a constructed response.

### BACKGROUND

To evaluate the understanding, comprehension, or skill of students in an academic environment, the students are tested. Typically, educators rely on multiple-choice examinations to evaluate students. Multiple-choice examinations quickly provide feedback to educators on the students' progress. However, multiple-choice examinations may reward students for recognizing an answer versus constructing or recalling an answer. Thus, another method of evaluating students utilizes test questions that require a constructed response. Examples of constructed responses include free-form, non-multiple choice responses such as essays, short answers, and show-your-work math responses. For some educators, use of a constructed response examination is preferred versus a multiple-choice examination because the constructed response examination requires the student to understand and articulate concepts in the tested subject matter. However, a length of time required to grade a constructed response may be considerable.

### SUMMARY

The present disclosure is directed to a computer-implemented method, system, and non-transitory computer-readable storage medium for scoring a constructed response. In an example computer-implemented method of scoring a constructed response, a constructed response for an item is received. The constructed response is processed with a processing system according to a set of grammar rules to generate a data structure for use in scoring the constructed response. The grammar rules specify a set of preferred responses for the item, where each preferred response merits a maximum score for the item. The grammar rules utilize a plurality of variables that specify legitimate word patterns for the constructed response. The data structure comprises information regarding i) whether the constructed response is included in the set of preferred responses, and ii) for each of the variables, whether a concept represented by the variable is present in the constructed response. It is determined, based on the information in the data structure, whether the constructed response is included in the set of preferred responses with the processing system, and if so, the maximum score is assigned to the constructed response. If the constructed response is not included in the set of preferred responses, a partial credit score for the constructed response is determined with the processing system by assessing from the data structure which ones of the concepts are present in the constructed response. The partial credit score is assigned based on the presence of the concepts.

An example system for scoring a constructed response includes a processing system and a computer-readable memory in communication with the processing system. The computer-readable memory is encoded with instructions for commanding the processing system to execute steps. In executing the steps, a constructed response for an item is received. The constructed response is processed with the processing system according to a set of grammar rules to generate a data structure for use in scoring the constructed response. The grammar rules specify a set of preferred responses for the item, where each preferred response merits a maximum score for the item. The grammar rules utilize a plurality of variables that specify legitimate word patterns for the constructed response. The data structure comprises information regarding i) whether the constructed response is included in the set of preferred responses, and ii) for each of the variables, whether a concept represented by the variable is present in the constructed response. It is determined, based on the information in the data structure, whether the constructed response is included in the set of preferred responses with the processing system, and if so, the maximum score is assigned to the constructed response. If the constructed response is not included in the set of preferred responses, a partial credit score for the constructed response is determined with the processing system by assessing from the data structure which ones of the concepts are present in the constructed response. The partial credit score is assigned based on the presence of the concepts.

In an example non-transitory computer-readable storage medium for scoring a constructed response, the computer-readable storage medium includes computer executable instructions which, when executed, cause a processing system to execute steps. In executing the steps, a constructed response for an item is received. The constructed response is processed with the processing system according to a set of grammar rules to generate a data structure for use in scoring the constructed response. The grammar rules specify a set of preferred responses for the item, where each preferred response merits a maximum score for the item. The grammar rules utilize a plurality of variables that specify legitimate word patterns for the constructed response. The data structure comprises information regarding i) whether the constructed response is included in the set of preferred responses, and ii) for each of the variables, whether a concept represented by the variable is present in the constructed response. It is determined, based on the information in the data structure, whether the constructed response is included in the set of preferred responses with the processing system, and if so, the maximum score is assigned to the constructed response. If the constructed response is not included in the set of preferred responses, a partial credit score for the constructed response is determined with the processing system by assessing from the data structure which ones of the concepts are present in the constructed response. The partial credit score is assigned based on the presence of the concepts.

### BRIEF DESCRIPTION OF THE DRAWINGS

FIG. 1 is a block diagram illustrating an example computer-based system for scoring a constructed response based on a grammar.

FIG. 2A illustrates an example item requesting a constructed response.

FIG. 2B illustrates an example of an expected response for an example item.

FIG. 2C illustrates variants of an expected response that are generated using an item-specific grammar.

FIG. 2D illustrates example responses that are not equivalent to an expected response but that include one or more concepts represented by variables of a grammar.

FIG. 2E illustrates responses to an item that merit no credit for the item.

FIG. 3 illustrates an example grammar for a specific test item.

FIG. 4 illustrates an example data structure for use in scoring a constructed response, where the constructed response associated with the data structure parses completely according to an example grammar.

FIGS. 5 and 6 illustrate example data structures for use in scoring constructed responses, where the constructed responses associated with the data structures do not parse completely according to a grammar.

FIG. 7 is a flowchart depicting operations of an example computer-implemented method for scoring a constructed response.

FIGS. 8A, 8B, and 8C depict example systems for scoring a constructed response.

### DETAILED DESCRIPTION

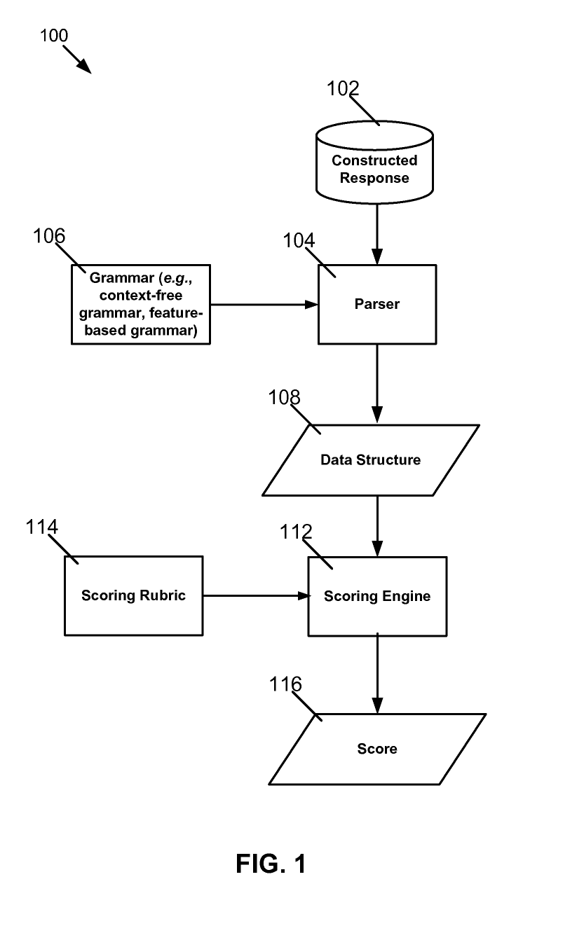

FIG. 1 is a block diagram 100 illustrating an example system for scoring a constructed response 102. In an example, the constructed response 102 includes one or more sentences that are generated by a user in response to an item (e.g., a test question), where the user may be a human. To score the constructed response 102, the example system of FIG. 1 may comprise a computer-based system that automatically determines whether the constructed response 102 includes one or more predefined concepts (i.e., key features) that should appear in a correct response to the item. As described in further detail below, a score 116 assigned to the constructed response 102 may comprise a measure of both the content and the grammaticality of the constructed response 102.

The score 116 for the constructed response 102 may be based in part on a grammar 106 that is defined specifically for the item. The term “grammar,” as used herein, refers to a set of rules (i.e., grammar rules or production rules) that specify a set of preferred responses for an item, each preferred response meriting a maximum score for the item. The rules of the grammar 106 utilize a plurality of variables (e.g., non-terminal symbols of the grammar 106) that specify legitimate word patterns for the constructed response 102. In an example, the grammar 106 may include a relatively compact rule set (e.g., containing 20-30 rules) capable of defining a relatively large set of preferred responses (e.g., containing several thousand responses) that merit the maximum score for the item. The grammar 106 may be, for example, a context-free grammar, a feature-based grammar, or a regular expression, as known by those of ordinary skill in the art. The grammar rules, and other aspects of the grammar such as preferred responses and other concepts, may be stored as any suitable data structure in memory of a computer system, such as that described elsewhere herein.

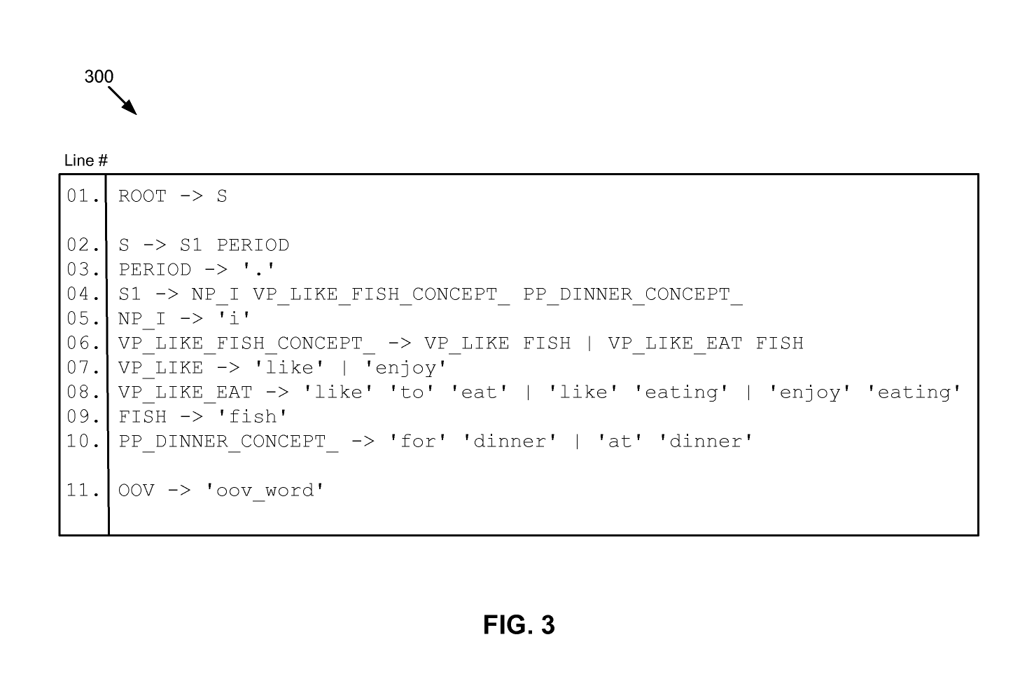

To illustrate an example use of the grammar 106, a test item may have an expected response of “I like to eat fish for dinner.” Such an expected response is an example of a preferred response for the item that would merit a maximum score. Grammar rules of the grammar 106 may be used to specify additional preferred responses that also merit the maximum score for the item, where the additional preferred responses may be variants of the expected response. A first additional preferred response may be a sentence, “I like eating fish for dinner.” A second additional preferred response may be a sentence, “I like fish for dinner.” As explained above, the grammar 106 may be able to define a relatively large number of such variants of the expected response using a relatively small number of grammar rules. An example item-specific grammar including grammar rules is illustrated in FIG. 3 and described in greater detail below.

The grammar rules of the grammar 106, in addition to specifying the set of preferred responses meriting the maximum score for the item, may further specify a set of concepts that should appear in a correct response to the item. Such concepts may specify legitimate word patterns (e.g., phrases or sentences) that should appear in the constructed response 102 to the item. As explained in further detail below, the presence or absence of such concepts in the constructed response 102 may provide evidence for determining a partial credit score for the constructed response 102. Such a partial credit score may be appropriate in situations where the constructed response 102 does not merit the maximum score for the item (i.e., the constructed response 102 is not included in the set of preferred responses meriting the maximum score for the item, as specified by the grammar rules of the grammar 106) but the constructed response 102 does include one or more of the concepts (i.e., key features) specified by variables (e.g., non-terminal symbols) of the grammar 106. Thus, in an example, the scoring of the constructed response 102 according to the grammar rules of the grammar 106 is not a binary determination (i.e., the scoring of the constructed response 102 does not merely indicate whether the constructed response 102 is in the language specified by the grammar 106 or not), and rather, the grammar rules may be used to assign one of a plurality of partial credit scores to the constructed response 102 based on the presence or absence of the concepts.

Each concept of the set of concepts may correspond to a variable of the grammar 106. A plurality of variables may be utilized by grammar rules of the grammar 106, with the variables specifying legitimate word patterns that should appear in the constructed response 102. Such legitimate word patterns may be phrases or entire sentences, for example. In an example, the variables utilized by the grammar rules comprise non-terminal symbols of the grammar 106. The term “non-terminal symbol,” as used herein, refers to a symbol of a grammar that is defined by a grammar rule of the grammar, where the symbol must be expanded using the defining grammar rule in order to fully understand the grammar. By contrast, the term “terminal symbol,” as used herein, refers to a symbol of a grammar that requires no further definition or expansion and that refers to actual text that is part of the grammar. A terminal symbol may thus represent a single word.

For instance, an example grammar may include, among other rules, a first grammar rule that is “NP->Det N” and a second grammar rule that is “N->fish.” In the first grammar rule, “NP” is a first non-terminal symbol (e.g., representing a noun phrase) that is defined as corresponding to a second non-terminal symbol “Det” (e.g., representing a determiner) followed by a third non-terminal symbol “N” (e.g., representing a noun). The second grammar rule specifies that the third non-terminal symbol may correspond to a terminal symbol that is actual text of the grammar, i.e., the word “fish.” In an example, a variable of the example grammar may be equivalent to the “NP” non-terminal symbol and may thus specify a legitimate word pattern based on the “Det N” portion of the first grammar rule. The legitimate word pattern based on the “Det N” portion of the first grammar rule may thus be, for example, a phrase that should appear in a constructed response to an item.

In the example of FIG. 1, the grammar rules of the grammar 106 may be defined specifically for the particular item (e.g., test question) that is used to elicit the constructed response 102. Thus, in an example, for each item, a corresponding grammar and set of grammar rules are defined. The corresponding grammar may be defined manually by humans or automatically using one or more algorithms. In an example in which the grammar is defined automatically using the one or more algorithms, the grammar may be automatically inferred from data using machine learning. An example item-specific grammar is illustrated in FIG. 3 and described in greater detail below. The types of items for which the item-specific grammars are defined may vary significantly. In one example, an expected response for an item may be a relatively specific text (e.g., an example expected response for an item may be, “Please work on exercise B on page 32. Match the sentences to the pictures. Work in pairs.”). In another example, an expected response for an item may be one or more phrases, sentences, or paragraphs that are less limited in scope and that may permit significant variation in a user's response.

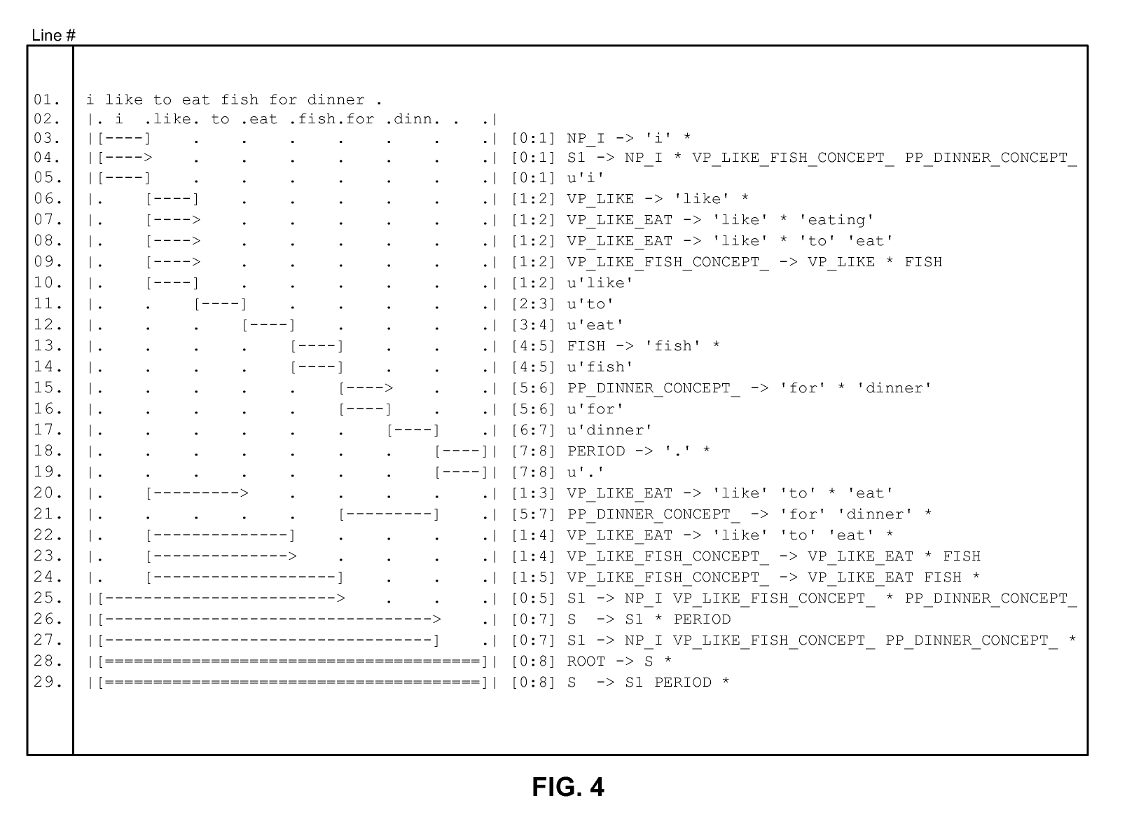

With reference again to the block diagram 100 of FIG. 1, the constructed response 102 may be received by a parser 104. The parser 104 may be used to parse the constructed response 102 according to the grammar rules of the grammar 106 to generate an output. The parser 104 may be implemented using any suitable combination of hardware, software and/or firmware, e.g., so that the processing system of a computer system described elsewhere herein is configured to carry out the required parsing operations. Specifically, the parser 104 may process (e.g., parse) the constructed response 102 according to the grammar rules of the grammar 106 to generate a data structure 108 for use in scoring the constructed response 102, wherein the data structure 108 may be stored in a memory of the computer system. The data structure 108 may include or be visualized using, for example, a parse chart or a parse tree, among other ways. The parser 104 may automatically generate the data structure 108, where the processing performed by the parser 104 may be automatic in the sense that the operations are carried out by one or more algorithms (e.g., parsing and/or processing algorithms) without a need for human decision making regarding substantive aspects of the processing during the processing. Example data structures that may be generated based on a parsing of a constructed response according to grammar rules of a grammar are illustrated in FIGS. 4-6 and described in further detail below. The parsing and generation of the data structures illustrated in FIGS. 4-6 may be generated, for example, using the Natural Language Toolkit (NLTK) known to those of ordinary skill in the art.

The data structure 108 may indicate, among other things, whether the constructed response 102 is included in the set of preferred responses specified by the grammar rules of the grammar 106 as meriting the maximum score for the item. This indication included in the data structure 108 may be based on whether the constructed response 102 can be parsed completely according to the grammar rules of the grammar 106. The constructed response 102 may be parsed completely according to the grammar rules of the grammar 106 when the parsing of the constructed response 102 achieves a “root” node of the grammar 106 that covers an entirety of the constructed response 102.

The data structure 108 may further indicate whether the concepts represented by the variables of the grammar 106 are present in the constructed response 102. In an example, certain non-terminal symbols of the grammar 106 may be specified as being “concept variables.” Such concept variables may be non-terminal symbols of the grammar 106 that have been determined to represent legitimate word patterns that should be included in a response to the item. The data structure 108 generated by the parser 104 may indicate whether the concepts represented by the concept variables are present in the constructed response 102. As described in greater detail below, such an indication regarding the presence or absence of the concepts may be used in assigning a partial credit score to the constructed response 102.

With reference again to the block diagram 100 of FIG. 1, the data structure 108 is received at a scoring engine 112. The scoring engine may be implemented using any suitable combination of hardware, software and/or firmware, e.g., so that the processing system of the computer system described elsewhere herein is configured to carry out the required scoring operations. The scoring engine 112 may comprise an automated scoring system configured to determine the score 116 for the constructed response 102 based on one or more criteria defined by a scoring rubric 114, which may be stored in memory using any suitable data structure. In an example, the automated scoring system may be a computer-based system for automatically scoring the constructed response 102. The scoring may be automatic in the sense that the scoring is carried out by one or more scoring algorithms without the need for human decision making regarding substantive aspects of the scoring during the computer-based scoring process.

The score 116 generated by the scoring engine 112 may provide a measure of the content of the constructed response 102, as reflected by the degree to which the constructed response 102 includes the concepts represented by the concept variables. The score 116 may further comprise a measure of the grammaticality of the constructed response 102. For example, for a grammar with concepts that include “learn to use” and “have you ever,” a constructed response that includes a first text sequence “learn to use have you ever” may be scored lower than a constructed response that includes a second text sequence “have you ever learned to use,” due to the lack of grammaticality of the first text sequence. Further examples of the use of the score 116 as a measure of both the content and the grammaticality of the constructed response 102 are provided below.

The scoring engine 112 may utilize the scoring rubric 114 to assign one of a plurality of different possible scores to the constructed response 102. Based on the scoring rubric 114, the scoring engine 112 may assign a maximum score to the constructed response 102 if the data structure 108 indicates that the constructed response 102 is included in the set of preferred responses defined by the grammar rules of the grammar 106 (i.e., the set of preferred responses meriting the maximum score for the item). This maximum score may be assigned, for example, based on an indication in the data structure 108 that the constructed response 102 was able to be parsed completely according to the grammar rules of the grammar 106.

Additionally, based on the scoring rubric 114, the scoring engine 112 may determine a partial credit score for the constructed response 102 if the data structure 108 indicates that the constructed response 102 is not included in the set of preferred responses defined by the grammar rules of the grammar 106. Specifically, the partial credit score may be one of a plurality of possible partial credit scores for the item that are included in the scoring rubric 114, and the partial credit score may be determined by assessing from the data structure 108 which ones of the concepts represented by the concept variables are present in the constructed response 102. In this manner, the score 116 may indicate not only whether the constructed response 102 is “correct” or “incorrect” (i.e., a binary scoring determination) but may rather be one of a plurality of possible partial credit scores for the constructed response 102. The partial credit score may be assigned, for example, based on an indication in the data structure 108 that the constructed response 102 was not able to be parsed completely according to the grammar rules of the grammar 106 but that the constructed response 102 included one or more of the concepts represented by the concept variables of the grammar 106.

The determining of the score 116 by the scoring engine 112 according to the scoring rubric 114 may be based on various different grading schemes. For instance, if the scoring engine 112 determines from the data structure 108 that the constructed response 102 can be parsed fully according to the grammar rules of the grammar 106, thus achieving a “root node” of the grammar 106 that covers an entirety of the constructed response 102, the scoring engine 112, applying the scoring rubric 114, may specify that the constructed response 102 should receive a maximum score (e.g., 3 points out of 3, in an example). If the scoring engine 112 determines from the data structure 108 that the constructed response 102 does not parse completely according to the grammar rules of the grammar 106, then the data structure 108 may be analyzed by the scoring engine 112 to determine which ones of the concepts are present in the constructed response 102. In an example, the data structure 108 may be analyzed to determine how many concept variables of the grammar 106 appear as completed in the data structure 108. For instance, if the data structure 108 indicates that there are (N−1) completed concept variables in the constructed response 102, where N is the number of concept variables that would appear in a complete parse of the constructed response 102, then the scoring rubric 114 may specify that a partial credit score (e.g., 2 points out of 3, where 1 point out of 3 is a lowest score) should be assigned to the constructed response 102.

In an example, the scoring rubric 114 may comprise information specifying a number of “low-score” concepts. Such low-score concepts may be represented by corresponding “low-score variables” (e.g., low-score non-terminal symbols) of the grammar 106, such that the constructed response 102 is assigned a lowest score (e.g., 1 point out of 3, in an example) if a concept represented by a low-score variable is present in the constructed response 102. In an example, the low-score variables may serve to identify constructed responses that include concepts defined by variables of the grammar 106, but where the included concepts appear in an incorrect order (e.g., “learn to use have you ever” as compared to “have you ever learned to use”). In another example, a low-score variable may be used to penalize a presence of certain symbols in the constructed response 102. For example, the grammar 106 may specify a low-score variable that represents the phrase “for fish,” and the scoring rubric 114 may specify that the constructed response 102 should be assigned a lowest score if the phrase “for fish” or a variant thereof appears in the constructed response 102.

Other scoring schemes may be employed by the scoring engine 112 through application of the scoring rubric 114 in other examples. In an example, the score 116 may be based on a 0% to 100% scale based on a percentage of the concepts that are included in the constructed response 102. In another example, a concept variable may be used to assign partial credit based on a presence of certain symbols in the constructed response 102. For example, the grammar 106 may include a concept variable that represents the phrase “for lunch,” and the scoring rubric 114 may specify that the constructed response 102 should be assigned a particular partial credit score if the phrase “for lunch” or a variant thereof appears in the constructed response 102.

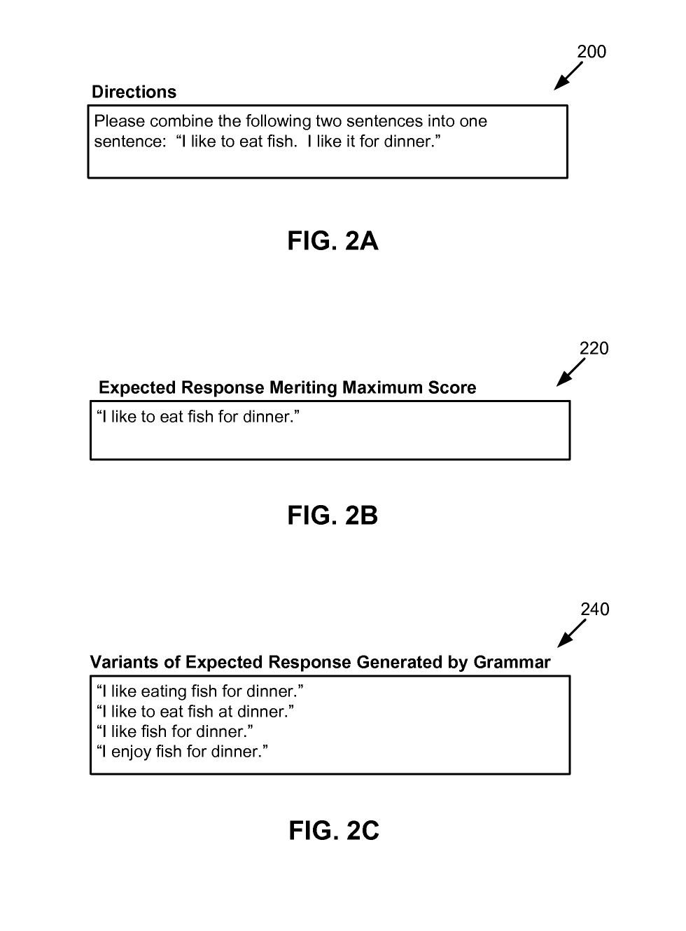

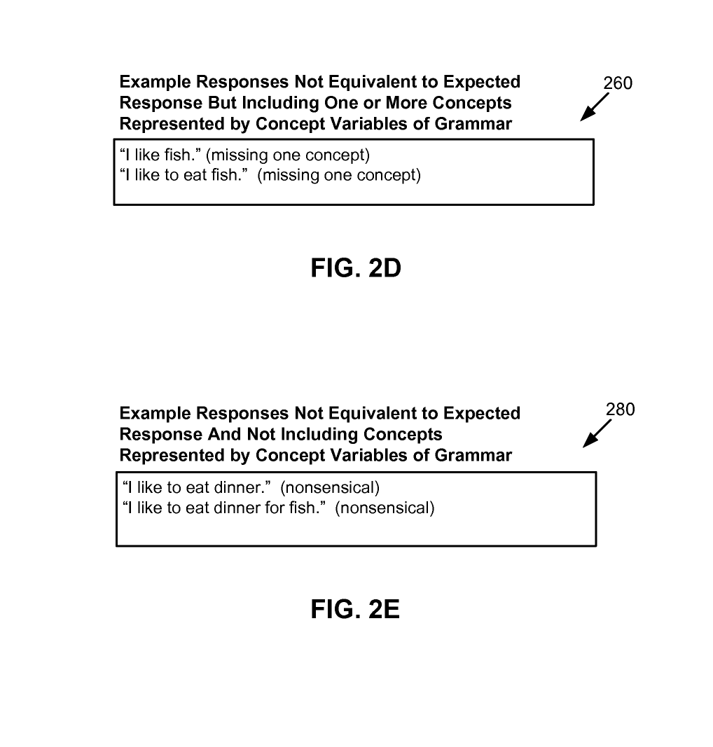

FIGS. 2A-6 may illustrate aspects of the computer-based system described above with reference to FIG. 1. Thus, as described below, these figures may illustrate, among other things, an example item (i.e., item 200 of FIG. 2A) requesting a constructed response and example grammar rules (i.e., grammar rules of grammar 300 illustrated in FIG. 3) defined specifically for the example item. The figures may further illustrate example constructed responses (i.e., constructed responses appearing in FIGS. 4-6) that are generated in response to the example item and aspects of the parsing and scoring operations used to score the example constructed responses. It should be understood that the examples of FIGS. 2A-6 are exemplary only, and that the scope of the computer-based system described herein extends to various different types of items, grammars, constructed responses, parsing operations, and scoring operations, etc.

FIG. 2A illustrates an example item 200 requesting a constructed response. The example item 200 may be, for example, a test question. As illustrated in FIG. 2A, the example item 200 includes directions that state, “Please combine the following two sentences into one sentence: ‘I like to eat fish. I like it for dinner.’” A grammar may be defined specifically for the example item 200 (e.g., manually by humans or automatically using one or more algorithms), and an example of a grammar defined specifically for the example item 200 is illustrated in FIG. 3 and described in further detail below.

FIG. 2B illustrates an example of an expected response 220 for the example item 200 of FIG. 2A. The expected response 220 of FIG. 2B reads, “I like to eat fish for dinner” If provided by a user in response to the example item 200 of FIG. 2A, such a response would merit a maximum score for the example item 200. Recognizing, however, that users may respond to the example item 200 in various other ways that are equivalent to the example response 220, a grammar may be used to define variants of the expected response 220, where such variants represent preferred responses for the item that each merit the maximum score. Thus, FIG. 3 illustrates an example grammar 300 including grammar rules (i.e., production rules) that may be used to define the variants of the expected response 220. The variants defined by the grammar rules of the grammar 300 may be preferred responses considered to be equivalent to the expected response 220. In determining the responses that comprise the set of preferred responses, the determination may be made on the criteria that a preferred response parses fully according to the grammar rules of the grammar 300.

In FIG. 3, each of lines 1-11 includes a single grammar rule for the grammar 300. For example, a first line of the grammar 300 includes a grammar rule “Root->S.” The grammar rules utilize variables (e.g., non-terminal symbols in an example), where certain of the variables are determined to be “concept variables” that specify legitimate word patterns (e.g., key phrases or sentences) that should appear in a response to the item. Such concept variables are described in further detail below. Example variables depicted in FIG. 3 may include the non-terminal symbols “ROOT” “S,” “S1,” “PERIOD,” “NP_I,” “VP_LIKE_FISH_CONCEPT_,” and “PP_DINNER_CONCEPT_,” among others. The “ROOT” variable may represent a complete response that fully parses under the grammar 300.

The grammar 300 further includes terminal symbols, where each terminal symbol may represent actual text of the grammar 300. Example terminal symbols depicted in FIG. 3 include the terminal symbols “i,” “fish,” “like,” “enjoy,” and “to,” among others. Additionally, at line 11 of the grammar 300, a rule (i.e., OOV->‘oov_word’) is utilized in parsing a response to convert all words that are not terminal symbols in the grammar 300 to a special terminal symbol “oov_word.” This rule may be included such that in parsing a response according to the grammar 300, the response will produce at least a partial parse. Otherwise, the parser may fail on responses including out-of-vocabulary words.

FIG. 2C illustrates variants 240 of the expected response 220 determined using a grammar that is specific to the item 200. As explained above, such variants may comprise, along with the expected response 220 of FIG. 2B, a set of preferred responses for the item that merit a maximum score. The grammar used to determine the variants 240 of FIG. 2C may be, for example, the example grammar 300 of FIG. 3, as described above. The variants 240 of the expected response 220 include a first sentence (“I like eating fish for dinner.”), a second sentence (“I like to eat fish at dinner.”), a third sentence (“I like fish for dinner.”), and a fourth sentence (“I enjoy fish for dinner.”). These preferred responses may comprise the set of all responses that can be parsed completely according to the grammar 300 of FIG. 3.

With reference again to FIG. 3, the grammar rules of the grammar 300, in addition to defining the set of preferred responses that parse fully according to the grammar 300, may further define a set of concepts that should appear in a correct response to the item 200. As explained above, the grammar rules may utilize variables (e.g., non-terminal symbols), where certain of the variables are determined to be “concept variables” that represent the concepts. Thus, each concept of the set of concepts may correspond to a particular variable of the grammar 300 that has been marked as a concept variable. In the example grammar 300 of FIG. 3, two concept variables are included: “VP_LIKE_FISH_CONCEPT” and “PP_DINNER_CONCEPT_.” The first concept variable, “VP_LIKE_FISH_CONCEPT_,” may represent phrases such as “like fish,” “enjoy fish,” “like to eat fish,” “like eating fish,” and “enjoy eating fish,” as illustrated in the example grammar 300. The second concept variable, “PP_DINNER_CONCEPT_,” may represent phrases such as “for dinner” and “at dinner.”

FIG. 2D illustrates example responses 260 that are not equivalent to the expected response 220 of FIG. 2B but that include one or more of the concepts defined by the grammar 300. The determination that the example responses 260 are not equivalent to the expected response 220 of FIG. 2B may be made on the basis that the example responses 260 cannot be fully parsed according to the grammar 300 of FIG. 3. As explained above, the grammar 300 may include two concept variables, “VP_LIKE_FISH_CONCEPT_” and “PP_DINNER_{—} CONCEPT_” and in order for a response to parse fully according to the grammar 300, both of the concepts represented by the two concept variables must be present in the response, among other conditions. Thus, although the example responses 260 each include the “VP_LIKE_FISH_{—} CONCEPT_” concept (e.g., the first response includes the phrase “like fish,” and the second response includes the phrase “like to eat fish”), neither of the responses 260 includes the “PP_DINNER_CONCEPT_” concept.

An automated scoring system (e.g., the scoring engine 112 of FIG. 1) may be used to determine partial credit scores for the responses 260 based on the presence of the “VP_LIKE_FISH_CONCEPT_” concept and the absence of the “PP_DINNER_CONCEPT_” concept in the responses 260. Partial credit scores that are less than the maximum score but higher than a score of zero may be appropriate for the responses 260 because the responses 260 are not equivalent to the expected response 220 of FIG. 2B (i.e., the example responses 260 do not parse fully according to the grammar 300) but the responses 260 do include one of the two concepts specified by the grammar 300. Thus, in an example, the scoring according to the grammar 300 is not a binary determination, and instead, the grammar 300 may be used in assigning one of a plurality of partial credit scores to the example responses 260 based on the presence or absence of the concepts.

FIG. 2E illustrates example responses 280 that are not equivalent to the expected response 220 of FIG. 2B and that include neither of the concepts represented by the concept variables of the grammar 300. As illustrated in FIG. 2E, the example responses 280 include neither the “VP_LIKE_FISH_CONCEPT_” concept nor the “PP_DINNER_CONCEPT_” concept of the grammar 300. Lacking such concepts, neither of the example responses 280 can be parsed fully according to the grammar 300 of FIG. 3. As explained in further detail below, an automated scoring system may be used to assign to each of the example responses 280 one of a plurality of partial credit scores based on the absence of these concepts.

FIG. 4 illustrates an example data structure for use in scoring a constructed response, where the constructed response is one that parses completely according to the example grammar 300 of FIG. 3. As described above, a constructed response generated in response to an item may be received by a parser (e.g., the parser 104 of FIG. 1). The parser may be used to parse the constructed response according to a set of grammar rules of a grammar to generate an output, where the output may include a data structure (e.g., a parse tree or parse chart), such as the data structure illustrated in FIG. 4. In an example, the Natural Language Toolkit (NLTK) known to those of ordinary skill in the art may be used to generate the data structures illustrated in FIGS. 4-6.

The data structure of FIG. 4 may indicate, among other things, i) whether the constructed response parses completely according to the grammar (e.g., whether the constructed response is included in a set of preferred responses specified by the grammar rules), and ii) whether concepts defined in the grammar are present or absent in the constructed response. The data structure may be processed by a scoring engine (e.g., the scoring engine 112 of FIG. 1) to generate a score for the constructed response based on one or more criteria (e.g., criteria that may be defined, for instance, in a scoring rubric). In an example, if the data structure indicates that the constructed response parses completely according to the grammar rules of the grammar, the constructed response may receive a maximum score for the item. If the data structure indicates that the constructed response does not parse completely according to the grammar, a partial credit score may be assigned to the response. The partial credit score may be determined by assessing from the data structure which ones of the concepts are present in the constructed response and then assigning the partial credit score based on the presence of the concepts.

In an example, the parser may automatically parse the constructed response according to the grammar rules to generate the data structure. The parsing is automatic in the sense that the parsing is carried out by parsing algorithm(s) according to the grammar rules without the need for human decision making regarding substantive aspects of the parsing during the parsing process. The parsing algorithms may be implemented using suitable language such as C, C++, JAVA, for example, and may employ some conventional parsing tools known to those of ordinary skill in the art for purposes of identifying word boundaries, sentence boundaries, punctuation, etc. (e.g., may utilize a chart parser, as known to those of ordinary skill in the art). In the example data structures illustrated in FIGS. 4-6, all tokens are in a lowercase form, but in other examples, both uppercase and lowercase tokens are used. For example, both uppercase and lowercase tokens may be used if capitalization is to be considered in assigning a score to a constructed response.

As illustrated in FIG. 4, the example data structure generated by the parser may provide a diagrammatic representation of which concept variables (e.g., non-terminal symbols of the grammar that are determined to be “concept non-terminal symbols”) of the grammar are satisfied in the constructed response, as well as a text based indication of the different rules and variables of the grammar. Specifically, each row of the data structure may represent a combination of a span and a grammar production rule. Brackets included in the data structure (e.g., [-------]) may indicate that the production rule has been completely instantiated at that span. Arrows (e.g., [------->]) may indicate partial rule completion.

The example data structure of FIG. 4 corresponds to a constructed response that reads, as indicated at line number 1, “I like to eat fish for dinner.” With reference to FIGS. 2A and 2B, this constructed response may represent the expected response 220 for the item 200. In generating the data structure, the constructed response may be parsed according to a set of grammar rules to generate a parsed text, and the parsed text may then be processed according to the grammar rules to generate the data structure. When this constructed response is parsed and processed according to the grammar rules, the parser finds a complete parse, as shown by the full double bar (e.g., [=======]) next to the ROOT symbol, as depicted at line 29 of the data structure. The data structure thus indicates that constructed response is able to be fully parsed according to the grammar rules, evidencing that the constructed response is included in the set of preferred responses specified by the grammar rules. A scoring engine may be configured to process the data structure to determine that the data structure indicates this condition, and accordingly, the scoring engine may assign a highest score to the constructed response (e.g., 3 points out of 3, in an example). The data structure of FIG. 4 may further indicate that in parsing the constructed response, all concepts of the grammar have been determined as being present in the response (e.g., both the VP_LIKE_FISH_CONCEPT_ and the PP_DINNER_CONCEPT_{—} concepts of the grammar 300 of FIG. 3 are included in the constructed response).

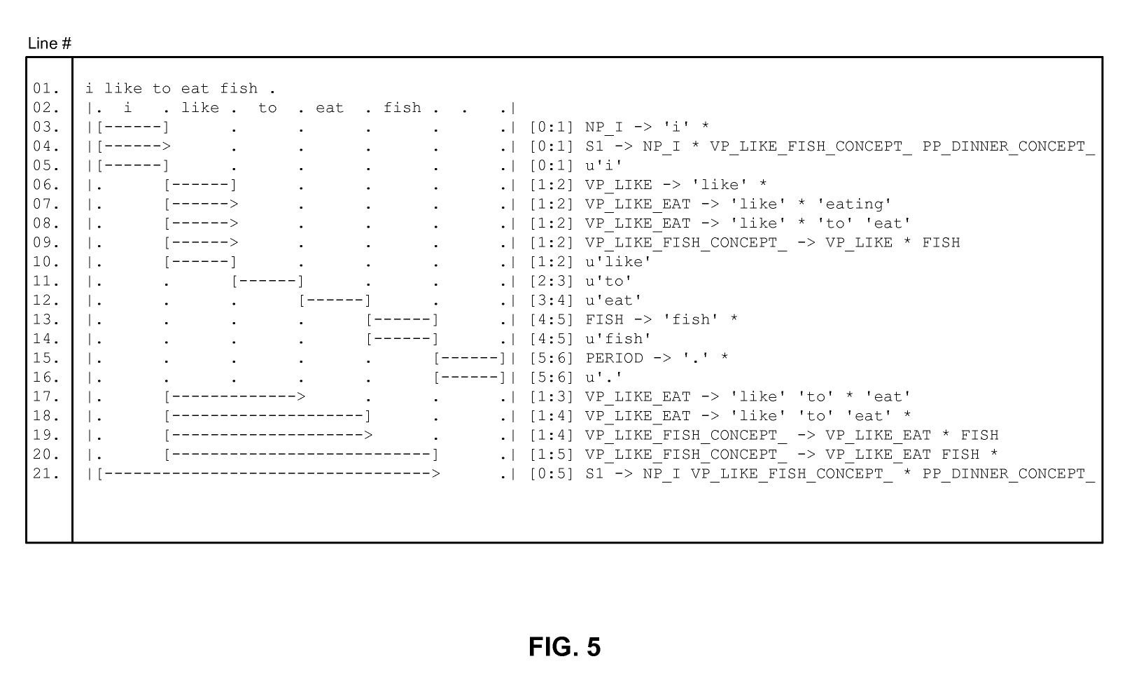

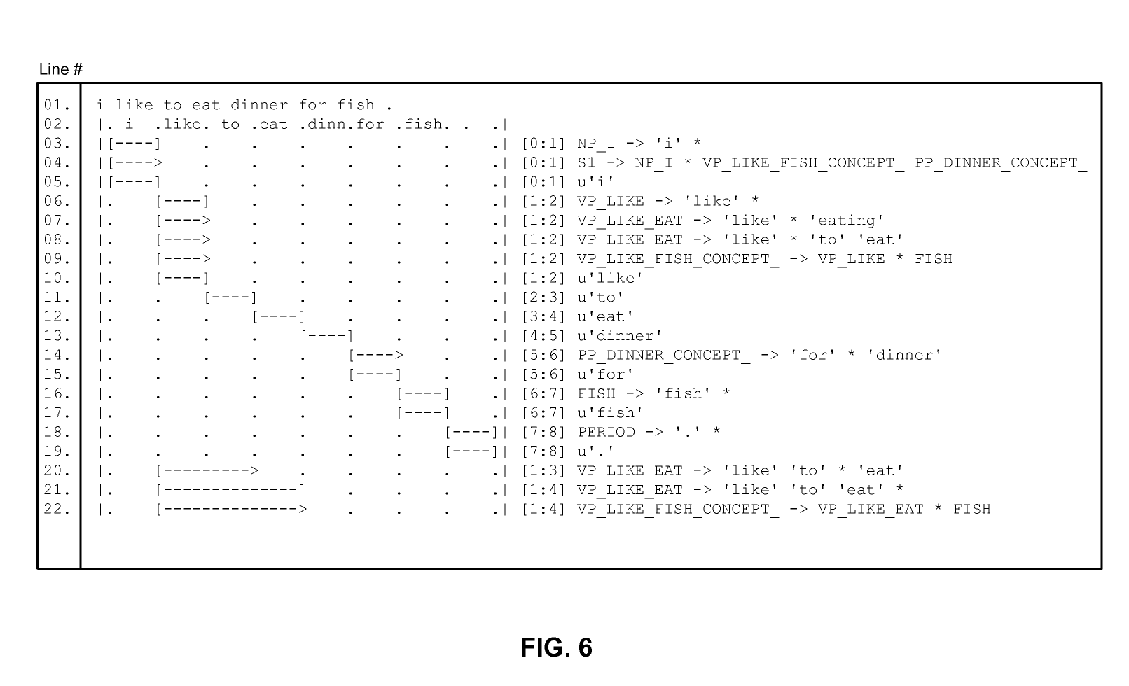

FIGS. 5 and 6 illustrate example data structures for use in scoring constructed responses, where the constructed responses associated with the data structures do not parse completely according to the example grammar 300 of FIG. 3. The example data structure of FIG. 5 corresponds to a constructed response that reads, as indicated at line number 1, “I like to eat fish.” With reference to FIGS. 2A and 2D, this constructed response may represent a response for the item 200 that does not include instances of all of the concepts of the grammar. Specifically, although the constructed response of FIG. 5 includes the concept “VP_LIKE_FISH_CONCEPT_,” it is missing the concept “PP_DINNER_CONCEPT_.” In line number 21 of the data structure of FIG. 5, the missing “PP_DINNER_CONCEPT_” is shown to the right of an asterisk, indicating that it is a missing part of the rule.

In an example, because N−1 of the concepts are indicated as being instantiated in complete form in the data structure of FIG. 5, where N is the total number of concepts expected for a response receiving a maximum score, a scoring engine configured to process this data structure may assign a partial credit score of 2 points out of 3 to the response. The scoring engine may assess from the data structure which ones of the concepts are present in the response and then determine the partial credit score based on a scoring rubric.

The example data structure of FIG. 6 corresponds to a constructed response that reads, as indicated at line number 1, “I like to eat dinner for fish.” With reference to FIGS. 2A and 2E, this constructed response may represent a response for the item 200 that includes neither the “VP_LIKE_FISH_CONCEPT_” concept nor the “PP_DINNER_CONCEPT_” concept. In an example, because neither of these concepts are indicated as being instantiated in complete form in the data structure, a scoring engine configured to process this data structure may assign a lowest partial credit score to the response (e.g., 1 point out of 3, in an example). Scoring schemes that differ from those utilized in FIGS. 4-6 may be used in other examples (e.g., assigning scores from 0-100% based on a percentage of the completed concepts). Additionally, in other example scoring schemes, special symbols may be included in the grammar rules for penalizing the presence of certain concepts in a constructed response. In an example, a grammar rule may be used to assign a lowest partial credit score to any response with the phrase “for fish.” In another example, a grammar rule may be used to assign partial credit to certain types of incorrect responses (e.g., if a response included “for lunch” instead of “for dinner”). It should be understood that the data structures illustrated in FIGS. 4-6 are exemplary only and that a parser may produce outputs of various other forms.

As described herein, an example system for automated scoring of a constructed response may utilize a grammar that has been specifically defined for an item. In an example, rather than specifying a single item-specific grammar for an item, different grammars may be specified that are representative of fully correct responses to the item and partially correct responses to the item. In another example, rather than specifying the single item-specific grammar for the item, different grammars may be specified for each concept in the expected response, and additionally, a separate grammar may be specified for the entire expected response. The approach of this example may be considered to be included in the single item-specific grammar approach described above with reference to FIGS. 1-6. This is because a grammar can be viewed as a recursive construction of simpler grammars. For example, a grammar for a full sentence may be seen as being defined based on grammars for the types of phrases that can appear in the full sentence.

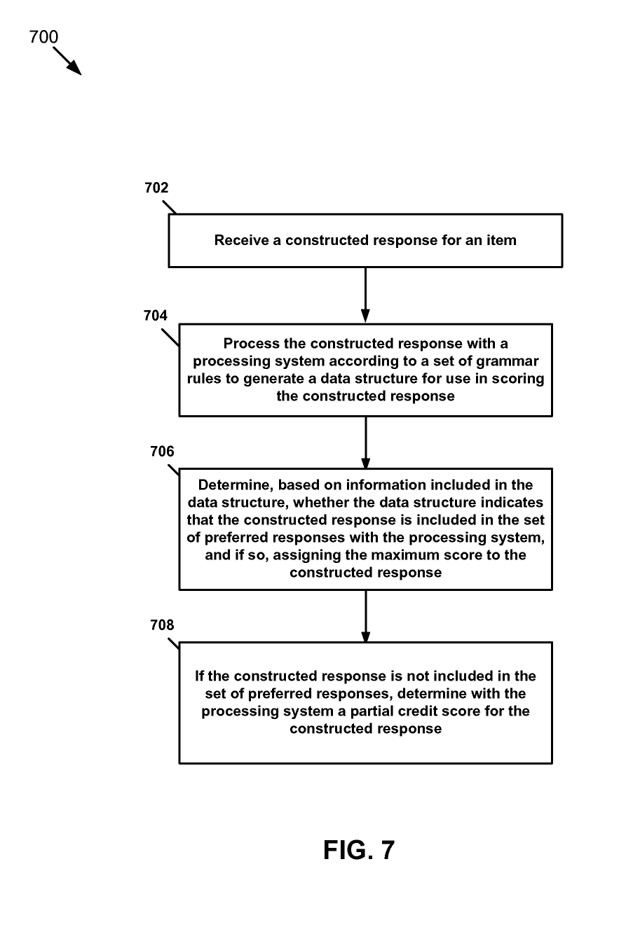

FIG. 7 is a flowchart 700 depicting operations of an example computer-implemented method for scoring a constructed response. At 702, a constructed response for an item is received. At 704, the constructed response is processed with a processing system of a computer system according to a set of grammar rules to generate a data structure for use in scoring the constructed response. The grammar rules specify a set of preferred responses for the item, where each preferred response merits a maximum score for the item. The grammar rules utilize a plurality of variables that specify legitimate word patterns for the constructed response. The data structure includes information that can be processed by a processing system of the computer system to determine i) whether the constructed response is included in the set of preferred responses, and ii) for each of the variables, whether a concept represented by the variable is present in the constructed response. At 706, it is determined, based on the information included in the data structure, whether the data structure indicates that the constructed response is included in the set of preferred responses with the processing system, and if so, the maximum score is assigned to the constructed response. At 708, if the constructed response is not included in the set of preferred responses, a partial credit score for the constructed response is determined with the processing system by assessing from the data structure which ones of the concepts are present in the constructed response. The partial credit score is assigned based on the presence of the concepts.

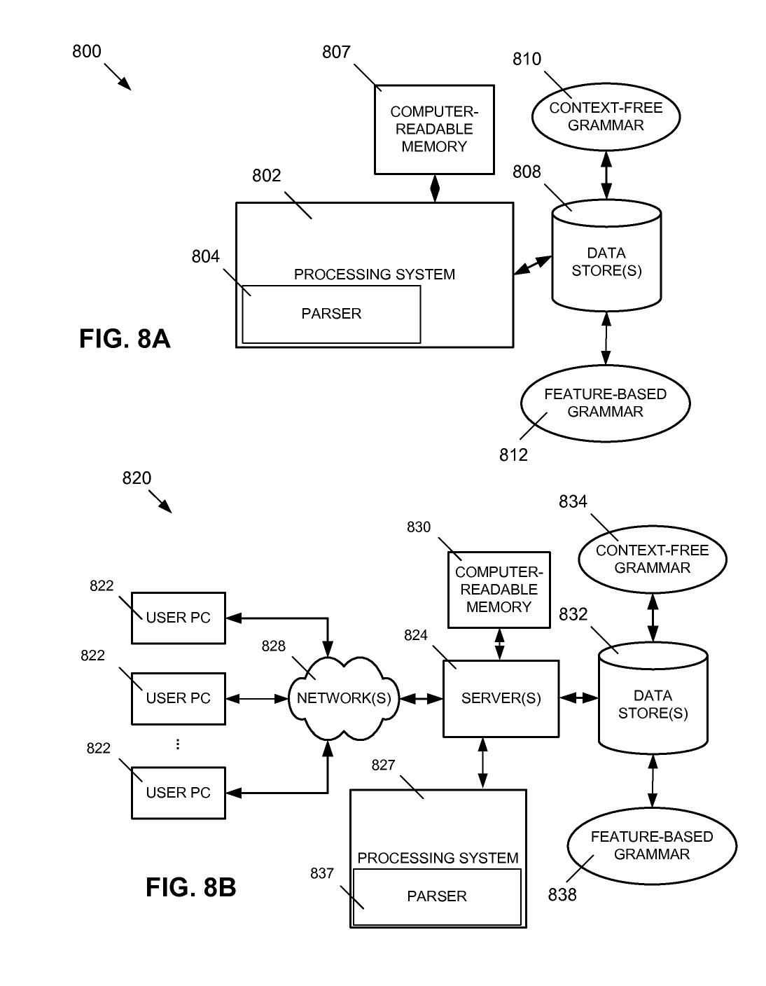

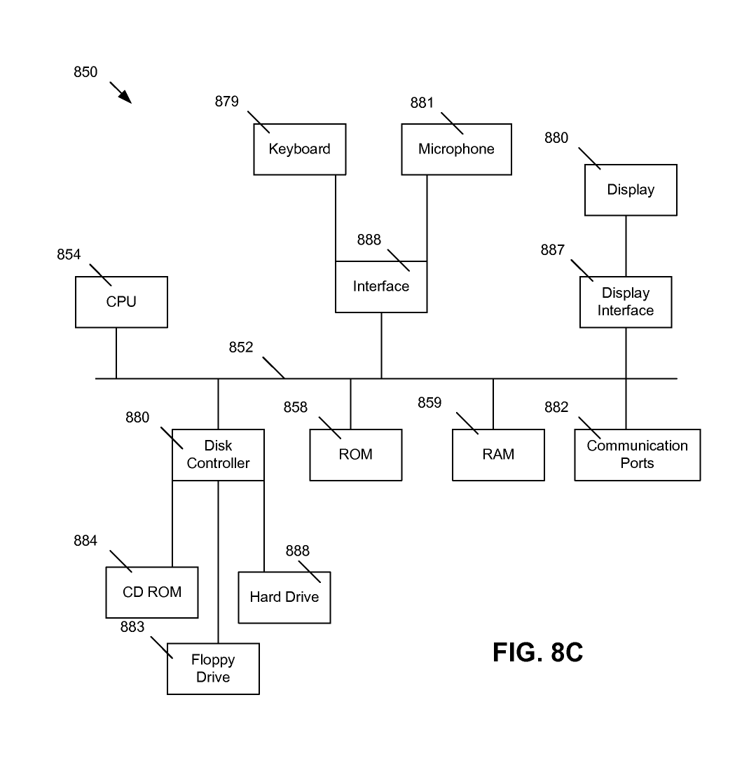

FIGS. 8A, 8B, and 8C depict example systems for implementing the approaches described herein for scoring a constructed response. For example, FIG. 8A depicts an exemplary system 800 that includes a standalone computer architecture where a processing system 802 (e.g., one or more computer processors located in a given computer or in multiple computers that may be separate and distinct from one another) includes a parser 804 being executed on the processing system 802. The processing system 802 has access to a computer-readable memory 807 in addition to one or more data stores 808. The one or more data stores 808 may include rules for a context free grammar 810 as well as rules for a feature-based grammar 812. The processing system 802 may be a distributed parallel computing environment, which may be used to handle very large-scale data sets.

FIG. 8B depicts a system 820 that includes a client-server architecture. One or more user PCs 822 access one or more servers 824 running a parser 837 on a processing system 827 via one or more networks 828. The one or more servers 824 may access a computer-readable memory 830 as well as one or more data stores 832. The one or more data stores 832 may include rules for a context free grammar 834 as well as rules for a feature-based grammar 836.

FIG. 8C shows a block diagram of exemplary hardware for a standalone computer architecture 850, such as the architecture depicted in FIG. 8A that may be used to contain and/or implement the program instructions of system embodiments of the present disclosure. A bus 852 may serve as the information highway interconnecting the other illustrated components of the hardware. A processing system 854 labeled CPU (central processing unit) (e.g., one or more computer processors at a given computer or at multiple computers), may perform calculations and logic operations required to execute a program. A non-transitory processor-readable storage medium, such as read only memory (ROM) 858 and random access memory (RAM) 859, may be in communication with the processing system 854 and may contain one or more programming instructions for performing the method for scoring a constructed response. Optionally, program instructions may be stored on a non-transitory computer-readable storage medium such as a magnetic disk, optical disk, recordable memory device, flash memory, or other physical storage medium.

In FIGS. 8A, 8B, and 8C, computer readable memories 807, 830, 858, 859 or data stores 808, 832, 883, 884, 888 may include one or more data structures for storing and associating various data used in the example systems for scoring a constructed response. For example, a data structure stored in any of the aforementioned locations may be used to relate grammar rules and a plurality of variables that specify legitimate word patterns for a constructed response. As another example, a data structure may be used to relate constructed responses with scores assigned to the constructed responses. Other aspects of the example systems for scoring a constructed response may be stored and associated in the one or more data structures (e.g., parse charts generated by a parser, etc.).

A disk controller 880 interfaces one or more optional disk drives to the system bus 852. These disk drives may be external or internal floppy disk drives such as 883, external or internal CD-ROM, CD-R, CD-RW or DVD drives such as 884, or external or internal hard drives 888. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 880, the ROM 858 and/or the RAM 859. The processor 854 may access one or more components as required.

A display interface 887 may permit information from the bus 852 to be displayed on a display 880 in audio, graphic, or alphanumeric format. Communication with external devices may optionally occur using various communication ports 882.

In addition to these computer-type components, the hardware may also include data input devices, such as a keyboard 879, or other input device 881, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A computer-implemented method for scoring a constructed response, the computer-implemented method comprising:
receiving a constructed response for an item;
processing the constructed response with a processing system according to a set of grammar rules to generate a data structure for use in scoring the constructed response, the grammar rules specifying a set of preferred responses for the item, each preferred response meriting a maximum score for the item, the grammar rules utilizing a plurality of variables that specify legitimate word patterns for the constructed response,
wherein the data structure comprises information regarding i) whether the constructed response is included in the set of preferred responses, and ii) for each of the variables, whether a concept represented by the variable is present in the constructed response;
determining with the processing system, based on the information included in the data structure, whether the constructed response is included in the set of preferred responses with the processing system, and if so, assigning the maximum score to the constructed response; and
if the constructed response is not included in the set of preferred responses, determining with the processing system a partial credit score for the constructed response by assessing from the data structure which ones of the concepts are present in the constructed response, and assigning the partial credit score based on the presence of the concepts.

2. The computer-implemented method of claim 1, wherein the grammar rules comprise production rules of a context-free grammar or a feature-based grammar.

3. The computer-implemented method of claim 1, wherein the plurality of variables include a low-score variable, and wherein the constructed response is assigned a lowest partial credit score if the concept represented by the low-score variable is present in the constructed response.

4. The computer-implemented method of claim 1, wherein the grammar rules utilize a second plurality of variables, wherein the plurality of variables is a subset of the second plurality of variables, and wherein the plurality of variables and the second plurality of variables are non-terminal symbols defined by grammar rules of the set of grammar rules.

5. The computer-implemented method of claim 1, wherein each of the concepts is a phrase or a sentence.

6. The computer-implemented method of claim 1, wherein the data structure indicates that the constructed response is included in the set of preferred responses if the constructed response parses completely according to the set of grammar rules.

7. The computer-implemented method of claim 1, wherein the partial credit score is determined based on a number of the concepts that are present in the constructed response.

8. A system for scoring a constructed response, the system comprising:
a processing system; and
a memory in communication with the processing system, wherein the processing system is configured to execute steps comprising:
receiving a constructed response for an item;
processing the constructed response according to a set of grammar rules to generate a data structure for use in scoring the constructed response, the grammar rules specifying a set of preferred responses for the item, each preferred response meriting a maximum score for the item, the grammar rules utilizing a plurality of variables that specify legitimate word patterns for the constructed response,
wherein the data structure comprises information regarding i) whether the constructed response is included in the set of preferred responses, and ii) for each of the variables, whether a concept represented by the variable is present in the constructed response;
determining, based on the information included in the data structure, whether the data the constructed response is included in the set of preferred responses with the processing system, and if so, assigning the maximum score to the constructed response; and
if the constructed response is not included in the set of preferred responses, determining with the processing system a partial credit score for the constructed response by assessing from the data structure which ones of the concepts are present in the constructed response, and assigning the partial credit score based on the presence of the concepts.

9. The system of claim 8, wherein the grammar rules comprise production rules of a context-free grammar or a feature-based grammar.

10. The system of claim 8, wherein the plurality of variables include a low-score variable, and wherein the constructed response is assigned a lowest partial credit score if the concept represented by the low-score variable is present in the constructed response.

11. The system of claim 8, wherein the grammar rules utilize a second plurality of variables, wherein the plurality of variables is a subset of the second plurality of variables, and wherein the plurality of variables and the second plurality of variables are non-terminal symbols defined by grammar rules of the set of grammar rules.

12. The system of claim 8, wherein each of the concepts is a phrase or a sentence.

13. The system of claim 8, wherein the data structure indicates that the constructed response is included in the set of preferred responses if the constructed response parses completely according to the set of grammar rules.

14. The system of claim 8, wherein the partial credit score is determined based on a number of the concepts that are present in the constructed response.

15. A non-transitory computer-readable storage medium for scoring a constructed response, the computer-readable storage medium comprising computer executable instructions which, when executed, cause a processing system to execute steps comprising:
receiving a constructed response for an item;
processing the constructed response according to a set of grammar rules to generate a data structure for use in scoring the constructed response, the grammar rules specifying a set of preferred responses for the item, each preferred response meriting a maximum score for the item, the grammar rules utilizing a plurality of variables that specify legitimate word patterns for the constructed response,
wherein the data structure comprises information regarding i) whether the constructed response is included in the set of preferred responses, and ii) for each of the variables, whether a concept represented by the variable is present in the constructed response;
determining, based on the information included in the data structure, whether the constructed response is included in the set of preferred responses with the processing system, and if so, assigning the maximum score to the constructed response; and
if the constructed response is not included in the set of preferred responses, determining with the processing system a partial credit score for the constructed response by assessing from the data structure which ones of the concepts are present in the constructed response, and assigning the partial credit score based on the presence of the concepts.

16. The non-transitory computer-readable storage medium of claim 15, wherein the grammar rules comprise production rules of a context-free grammar or a feature-based grammar.

17. The non-transitory computer-readable storage medium of claim 15, wherein the plurality of variables include a low-score variable, and wherein the constructed response is assigned a lowest partial credit score if the concept represented by the low-score variable is present in the constructed response.

18. The non-transitory computer-readable storage medium of claim 15, wherein the grammar rules utilize a second plurality of variables, wherein the plurality of variables is a subset of the second plurality of variables, and wherein the plurality of variables and the second plurality of variables are non-terminal symbols defined by grammar rules of the set of grammar rules.

19. The non-transitory computer-readable storage medium of claim 15, wherein each of the concepts is a phrase or a sentence.

20. The non-transitory computer-readable storage medium of claim 15, wherein the data structure indicates that the constructed response is included in the set of preferred responses if the constructed response parses completely according to the set of grammar rules.

21. The non-transitory computer-readable storage medium of claim 15, wherein the partial credit score is determined based on a number of the concepts that are present in the constructed response.
